(19) United States
(12) Patent Application Publication
(10) Pub. No.: US 2023/0378773 A1
(43) Pub. Date: Nov. 23, 2023

(54) DUAL CHARGER ARCHITECTURE FOR FOLDABLE MOBILE COMPUTING DEVICES

(71) Applicant: Google LLC, Mountain View, CA (US)

(72) Inventors: ChiaMing Chang, New Taipei City (TW); Weichih Liao, Taoyuan City (TW); Po-chang Lu, Taoyuan City (TW); JhengFong Lyu, New Taipei City (TW); Chung-Yi Pan, New Taipei City (TW)

(21) Appl. No.: 18/246,837

(22) PCT Filed: Oct. 8, 2020
(86) PCT No.: PCT/US2020/070634

§ 371 Date: Mar. 27, 2023

(51) Int. Cl. H02J 7/00

(52) U.S. Cl. CPC H02J 7/0018; H02J 7/0042

(57) ABSTRACT

An example foldable mobile computing device includes a first side comprising: a first power storage device (PSD); a first charger configured to output current to charge the first PSD; and a first reverse blocking component; a second side configured to articulate relative to the first side about a hinge, the second side comprising: a second PSD; a second charger configured to output current to charge the second PSD; and a second reverse blocking component; a flexible printed circuit connected to the first side and the second side; and one or more components configured to operate using power sourced, in parallel, from the first PSD and the second PSD, wherein the power sourced by the one or more components from the first PSD flows through the first reverse blocking component and the power sourced by the one or more components from the second PSD flows through the second reverse blocking component.

### BACKGROUND

Foldable mobile computing devices, such as mobile phones, may include a power storage device, such as a battery. The power storage device may be a relatively heavy component of the foldable mobile computing device. Some foldable mobile computing devices include a first power storage device located on one side of the fold and a second power storage device located on another side of the fold. By locating a first power storage device on one side of the fold and a second power storage device on the other side of the fold, the weight of the foldable mobile computing device may be relatively balanced when compared to a foldable mobile computing device having a single power storage device. In such an arrangement, one power storage device of a foldable mobile computing device having multiple power storage devices may be smaller than the other(s) power storage devices due to there being less available volume in one side of the fold for placement of the power storage device.

### SUMMARY

A foldable mobile computing device may include at least two power storage devices, with at least one power storage device being located in a first side of the foldable mobile computing device and at least one power storage device being located in a second side of the mobile computing device. The foldable mobile device may include an interconnection, such as flexible printed circuitry, to transport electrical signals between the first side and the second side. For instance, the interconnection may transport a common system power signal (e.g., Vsys) that sources electrical power from both the first power storage device and the second power storage device. An on-board charger of the foldable mobile device may output a power signal to charge the power storage devices. However, using a single charger to charge both the first and second power storage devices may present one or more disadvantages. As one example, where the power storage devices have different desired charging currents (e.g., due to having different capacities), a resistance of the interconnection may prevent the power storage devices from being charged at their desired charging currents.

In accordance with one or more aspects of this disclosure, a foldable mobile computing device may include a separate charger for each power storage device. For instance, a first side of the foldable mobile computing device may include a first power storage device and a first charger configured to provide a power signal to charge the first power storage device and a second side of the foldable mobile computing device may include a second power storage device and a second charger configured to provide a power signal to charge the second power storage device. The foldable mobile computing device may further include a reverse blocking component for each of the chargers. For instance, the foldable mobile computing device may include a first reverse blocking component configured to prevent charging current provided by the second charger from flowing to the first power storage device and a second reverse blocking component configured to prevent charging current provided by the first charger from flowing to the second power storage device. As such, the first charger may output a first power signal to charge the first power storage device at a first charging current, without current from the first power signal flowing through the second power storage device. The second charger may similarly output a second power signal to charge the second power storage device at a second charging current, without current from the second power signal flowing through the first power storage device. In this way, the first power storage device and the second power storage device may be independently charged while still providing a common system power signal (e.g., Vsys) that sources electrical power from both the first power storage device and the second power storage device.

In one example, a foldable mobile computing device includes: a first side comprising: a first power storage device; a first charger configured to output current to charge the first power storage device; and a first reverse blocking component; a second side configured to articulate relative to the first side about a hinge, the second side comprising: a second power storage device; a second charger configured to output current to charge the second power storage device; and a second reverse blocking component; a flexible printed circuit connected to the first side and the second side; and one or more components configured to operate using electrical power sourced, in parallel, from the first power storage device and the second power storage device, wherein the electrical power sourced by the one or more components from the first power storage device flows through the first reverse blocking component and the electrical power sourced by the one or more components from the second power storage device flows through the second reverse blocking component.

In another example, a method includes outputting, at a first time and by a first charger located on a first side of a foldable mobile computing device, current to charge a first power storage device located on the first side; outputting, at the first time and by a second charger located on a second side of the foldable mobile computing device, current to charge a second power storage device located on the second side; blocking, at the first time and by a first reverse blocking component, current output by the second charger from flowing to the first power storage device; and blocking, at the first time and by a second reverse blocking component, current output by the first charger from flowing to the second power storage device.

Additional features, advantages, and embodiments of the disclosed subject matter may be set forth or apparent from consideration of the following detailed description, drawings, and claims. Moreover, it is to be understood both the foregoing summary and the following detailed description are illustrative and are intended to provide further explanation without limiting the scope of the claims.

### BRIEF DESCRIPTION OF THE DRAWINGS

FIG. 1 is a block diagram illustrating a representation of a foldable mobile computing device in accordance with various aspects of this disclosure.

FIGS. 2A-2D are signal flow diagrams illustrating example current flow through a foldable mobile device that includes multiple power storage devices and multiple chargers, in accordance with one or more aspects of this disclosure.

FIG. 3 is a flow diagram illustrating example operations of a foldable mobile device that includes multiple power storage devices and multiple chargers, in accordance with one or more techniques of this disclosure.

### DETAILED DESCRIPTION

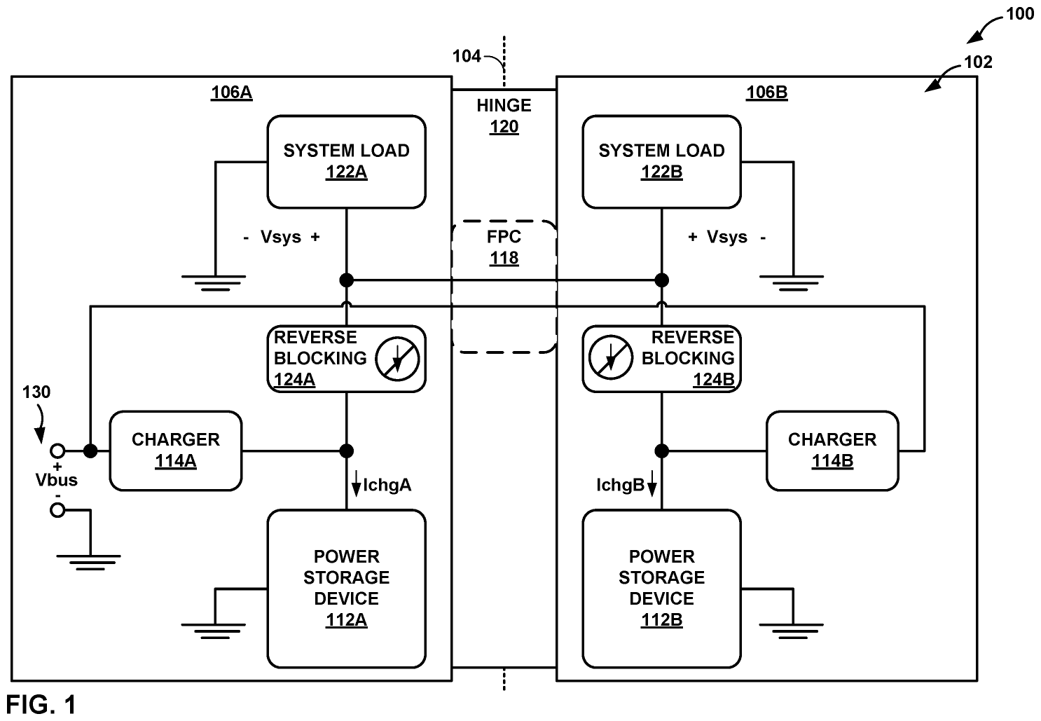

FIG. 1 is a block diagram illustrating a representation of a foldable mobile computing device in accordance with various aspects of this disclosure. Foldable mobile computing device 100 may represent any type of mobile computing device capable of folding or rotating along an axis 104, including along a centered axis or an off-center axis. While described herein with respect to foldable mobile computing device 100, any type of device capable of being powered by two or more power storage devices may be configured according to the techniques described in this disclosure. Examples of such devices may include a mobile phone (including a so-called “smartphone”), smart glasses, a smart watch, a portable speaker (including a portable smart speaker), a laptop computer, a portable gaming system, a wireless gaming system controller, and the like.

Foldable mobile computing device 100 may include a housing 102 having a hinge 120 or other element that enables folding along, or rotating about, an axis 104, having a first side 106A and a second side 106B. Housing 102 may be formed from most any material such as metal (including aluminum), plastics (including most any polymer), glass, carbon fiber, etc. along with combinations of the materials in which first side 106A may have different or the same materials as second side 106B. In some examples, first side 106A may be the same or approximately the same size (within manufacturing tolerances) as second side 106B.

In other examples, first side 106A may be a different size than second side 106B. For example, first side 106A may only cover, when folded along axis 104, a portion of second side 106B (and not cover nearly the entirety of second side 106B). Similarly, in some examples, second side 106B may only cover, when folded along axis 104, a portion of first side 106A (and not cover nearly the entirety of first side 106A).

Foldable mobile computing device 100 may also include a first power storage device 112A and a second power storage device 112B (collectively, “power storage devices 112”). First power storage device 112A may represent any type of electrical device capable of being charged via a power source (including fixed power sources accessible via electrical sockets, portable power sources, such as power banks comprised of, as one example, high wattage batteries, or wireless charging devices) and storing energy when unconnected from any power source. One example of first power storage device 112A is a battery, such as a lithium-ion battery, a nickel-cadmium battery, or any other type of rechargeable battery such as nickel-metal hydride, lead acid or lithium ion polymer.

Second power storage device 112B may be similar to first power storage device 112A, but may have a different wattage, power storage capacity (as defined in milliamp hour, or mAh), size, configuration, etc., such variation being referred to herein as asymmetrical. First power storage device 112A and second power storage device 112B may be referred to as batteries battery cells, cells, or battery packs. Various aspects of the techniques may be implemented with respect to any type of power storage device capable of powering a foldable mobile computing device 100 or any of the other devices discussed throughout this disclosure.

First power storage device 112A may be located in first side 106A. Second power storage device 112B may be located in second side 106B. In some examples, first power storage device 112A may be larger than second power storage device 112B as there may be less available space in second side 106B due to other components of foldable mobile computing device 100, such as processing circuitry 108, being located in second side 106B. The difference in size between first power storage device 112A and second power storage device 112B may result in a difference in power storage capacities. For instance, second power storage device 112B may have a capacity of 5000 mAh and first power storage device 112A may have a capacity of 3000 mAh. The difference in size between first power storage device 112A and second power storage device 112B may also result in a difference in an impedance of first power storage device 112A and an impedance of second power storage device 112B. In some examples the impedance of each or either of first power storage device 112A or second power storage device 112B may be referred to as a pack impedance.

Foldable mobile computing device 100 may include system load 122A and/or system load 122B, which may represent components that operate using electrical energy sourced from power storage devices 112. Some examples of such components that may be included in system load 122A and/or system load 122B include processing circuitry, display(s), modem circuitry, global positioning system (GPS) electronics, accelerometers, gyroscopes, audio processing circuitry (e.g., a headphone jack and accompanying circuitry), one or more speakers, light emitting diodes (LEDs), one or more cameras, antenna(s), radio frequency circuitry, and the like. In one specific example, system load 122A and/or system load 122B may include a power management integrated circuit (PMIC) that controls operation of charger 114A and/or charger 114B.

As shown in FIG. 1, system load 122A may be located on first side 106 and system load 122B may be located on second side 106B. In this way, system load 122A may represent a first set of components that are configured to operate using electrical power sourced from power storage devices 112 and system load 122B may represent a second set of components that are configured to operate using electrical power sourced from power storage devices 112.

Flexible printed circuit (FPC) 118 may be configured to transport electrical signals between first side 106A and second side 106B. For instance, FPC 118 may include a plurality of traces that each carry an electrical signal between a board (e.g., a printed circuit board) of first side 106A and a board of second side 106B.

Foldable mobile computing device 100 may include a charger configured to output a power signal to charge power storage devices. For instance, foldable mobile computing device 100 may include charger 114A on first side 106A that is configured to output a power signal with current IchgA to charge first power storage device 112A on first side 106A. In general, it may be desirable to charge a power storage device at what is referred to as a 1C charge rate. A 1C charge rate may be achieved by providing a power storage device with a charging current that is equal to a capacity of the power storage device. For instance, where first power storage device 112A has a capacity of 2000 mAh, charger 114A may achieve a 1C charge rate for first power storage device 112A by outputting the power signal with IchgA equal to 2000 mA. Similarly, where first power storage device 112A has a capacity of 2000 mAh, charger 114A may achieve a 0.5 C charge rate for first power storage device 112A by outputting the power signal with IchgA equal to 1000 mA.

In some examples, multiple different power storage devices may be charged using a single power signal provided by a single charger. In such cases, were the different power storage devices have different capacities, it may be desirable for different amounts of current to flow to each power storage device. For instance, where a first power storage device has a capacity of 2000 mAh and a second power storage device has a capacity of 3000 mAh, it may be desirable for the single charger to output the single power signal with a current of 5000 mA with 2000 mA flowing to the first power storage device and 3000 mA flowing to the second power storage device. However, due to various factors, simply connecting both the first power storage device and the second power storage device in parallel may not result in the desired allotment of current. For instance, where the first power storage device and the charger are located on a first side of a foldable mobile computing device and the second power storage device is located on a second side of the foldable mobile computing device, a resistance of an interconnection (e.g., a resistance of a FPC) between the two sides may cause more current to flow to the first power storage device than desired.

To overcome the undesirable current allocation, a device may include one or more regulators through which charging current flows. For instance, the device may include one or both of a first regulator that regulates an amount of current flowing to the first power storage device and a second regulator that regulates an amount of current flowing to the second power storage device. Such an arrangement may enable both the first power storage device and the second power storage device to be charged at a 1C charge rate using a single power signal output by a single charger. However, the use of such regulator(s) may present one or more disadvantages. For instance, operation of the regulator(s) may consume power, which may generate heat. In addition to wasting power, such generation of heat may undesirably impact operation of other components of the device. For instance, the heat generated by the regulator(s) may heat one or more processors (e.g., one or more application processors) of the device, which in-turn may have to be slowed (e.g., throttled back or operated at a reduced clock speed) to avoid causing damage.

In accordance with one or more aspects of this disclosure, a foldable mobile computing device that includes power storage devices distributed across multiple sides may include multiple chargers. For instance, as shown in FIG. 1, foldable mobile computing device 100 may include charger 114A configured to output a power signal to charge first power storage device 112A on first side 106A and charger 114B configured to output a power signal to charge second power storage device 112B on second side 106B. Chargers 114A and 114B (collectively, “chargers 114”) may operate independently such that each may output a power signal with a different current level. As such, charger 114A may output a power signal with current level selected to achieve a 1C charge rate for first power storage device 112A and charger 114B may output a power signal with a current level selected to achieve a 1C charge rate for second power storage device 112B. For instance, where first power storage device 112A has a capacity of 1000 mAh and second power storage device 112B has a capacity of 5000 mAh, charger 114A may output a power signal such that current level IchgA is 1000 mA and charger 114B may output a power signal such that current level IchgB is 5000 mA.

As discussed above, chargers 114 may generate power signals such that desired amounts of current flow to power storage devices 112. In some examples, such as where some of the current in the power signal generated by a charger of chargers 114 is used to operate a system load of system loads 122, foldable mobile computing device 100 may include current sensors at the inputs of power storage devices 112 and chargers 114 may implement a feedback loop using measurements from the current sensors. For instance, charger 114A may adjust a current level of a power signal being output by charger 114A based on a current sensor at an input to first power storage device 112A (e.g., a current sensor that measures IchgA) and charger 114B may adjust a current level of a power signal being output by charger 114B based on a current sensor at an input to second power storage device 112B (e.g., a current sensor that measures IchgB). Chargers 114 may be any suitable design capable of generating an output power signal. In some examples, chargers 114 may be switched-mode power converters such as buck, boost, buck-boost, Cuk (also known as a two-inductor inverting converter), flyback, or any other type of regulated DC/DC converter.

Foldable mobile computing device 100 may include power receiving component 130 that is configured to receive electrical energy from an external device via any suitable modality. Examples of external devices include, but are not limited to, mains power adapters, power banks (e.g., external battery packs), and the like. Examples of modalities include, but are not limited to, wired connections (e.g., universal serial bus (USB) connections) and wireless connections (e.g., inductive power transfer, such as wireless charging in accordance with the Qi Standard).

Chargers 114 may generate the power signals using electrical energy received via power receiving component 130, denoted in FIG. 1 as Vbus. As shown in FIG. 1, some of the received electrical energy may be transported to charger 114B via FPC 118. The traces of FPC 118 via which such received electrical energy is transferred may be different than traces of FPC 118 used for a common system power net, as discussed below.

While located on different sides of foldable mobile computing device 100, power storage devices 112 may both be used to generate a common system power signal to power one or more components. For instance, electrical energy from power storage devices 112 may be used to generate common system power signal with voltage Vsys that is used to operate system loads 122. As shown in FIG. 1, the common system power signals in each of first side 106A and second side 106B may be tied together via flexible printed circuit 118 to form a common system power net. In such an arrangement, if FPC 118 were to have zero resistance, power storage devices 112 would be electrically in parallel. The use of a common system power net may provide various advantages (e.g., over separate power nets on each side), such as enabling components of system loads 122 on both sides 106 to operate using power sourced from power storage devices 112 thereby avoiding a scenario where a system load on one side depletes a power storage device on that side while a power storage device on a different side still has significant remaining charge. When combined with the aforementioned use of charger 114A and charger 114B, such an arrangement may produce undesirable results. For instance, current from the power signal output by charger 114A may flow across FPC 118 and vice versa. Such cross flowing of current may interfere with the charging of power storage devices 112.

In accordance with one or more aspects of this disclosure, foldable mobile computing device 100 may include reverse blocking components 124A and 124B (collectively, “reverse blocking components 124”) to asymmetrically isolate current flows. For instance, reverse blocking component 124A may be configured to allow current to flow from charger 114A and/or first power storage device 112A to system loads 122 while blocking current from charger 114B and second power storage device 112B from flowing to charger 114A and first power storage device 112A. Similarly, reverse blocking component 124B may be configured to allow current to flow from charger 114B and/or second power storage device 112B to system loads 122 while blocking current from charger 114A and first power storage device 112A from flowing to charger 114B and second power storage device 112B. Reverse blocking components 124 may be any suitable component or combination of components capable of enabling asymmetrical current flow. For instance, each of reverse blocking components 124 may operate as an ideal diode.

As a result, in some examples, such as where power storage devices 112 are being charges and system loads 122 are not drawing any power, no current may flow across FPC 118 on the traces used for the common system power net. In this way, foldable mobile computing device 100 may achieve the desirable ability to have a common system power net, charge both of power storage devices 112 at a 1C charge rate, and omit regulators between chargers 114 and power storage devices 112.

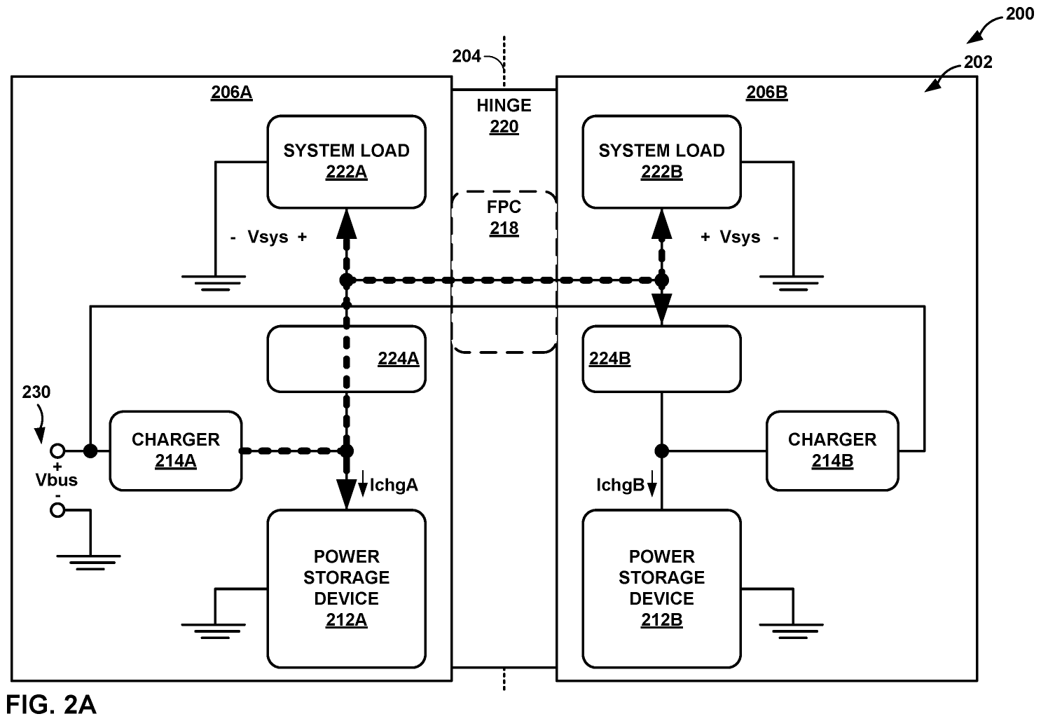

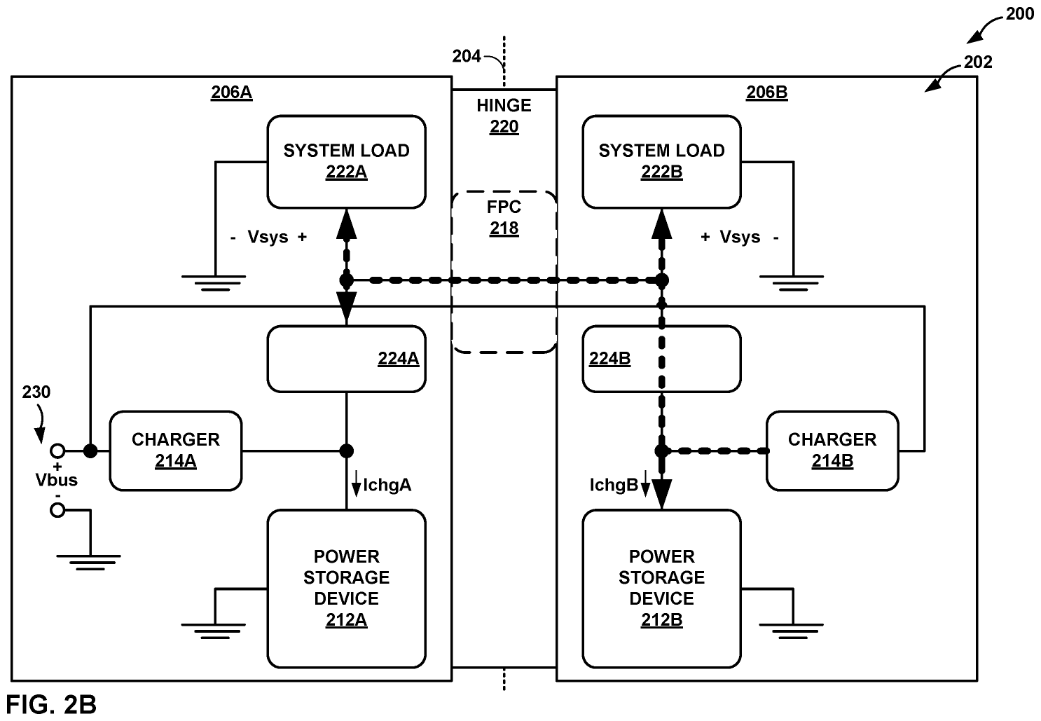

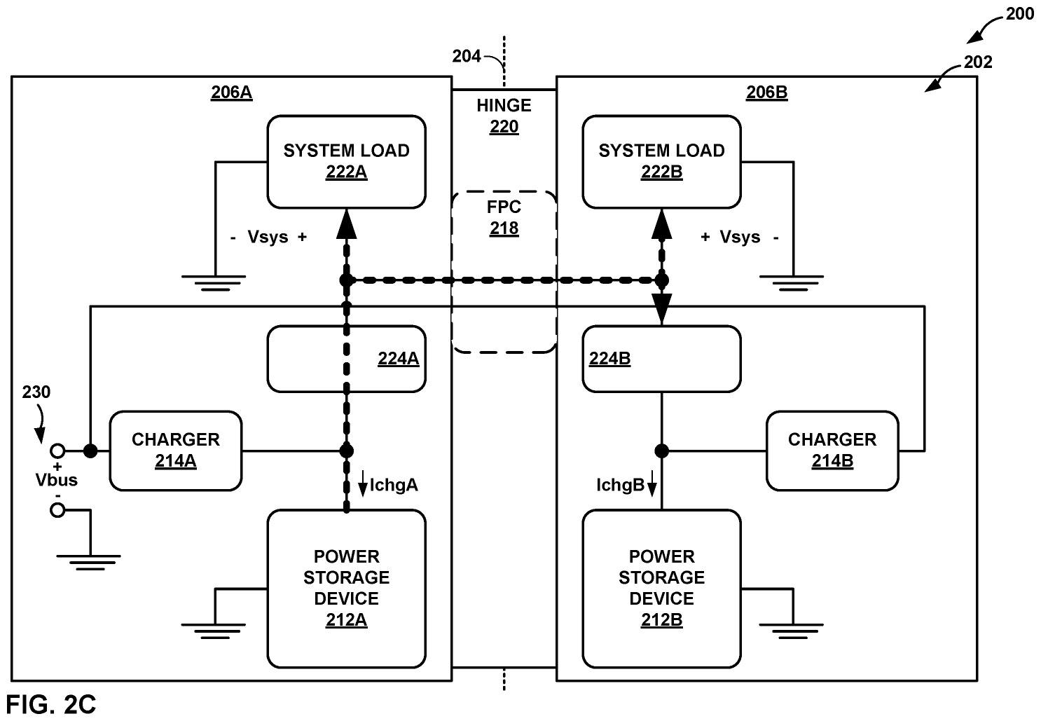

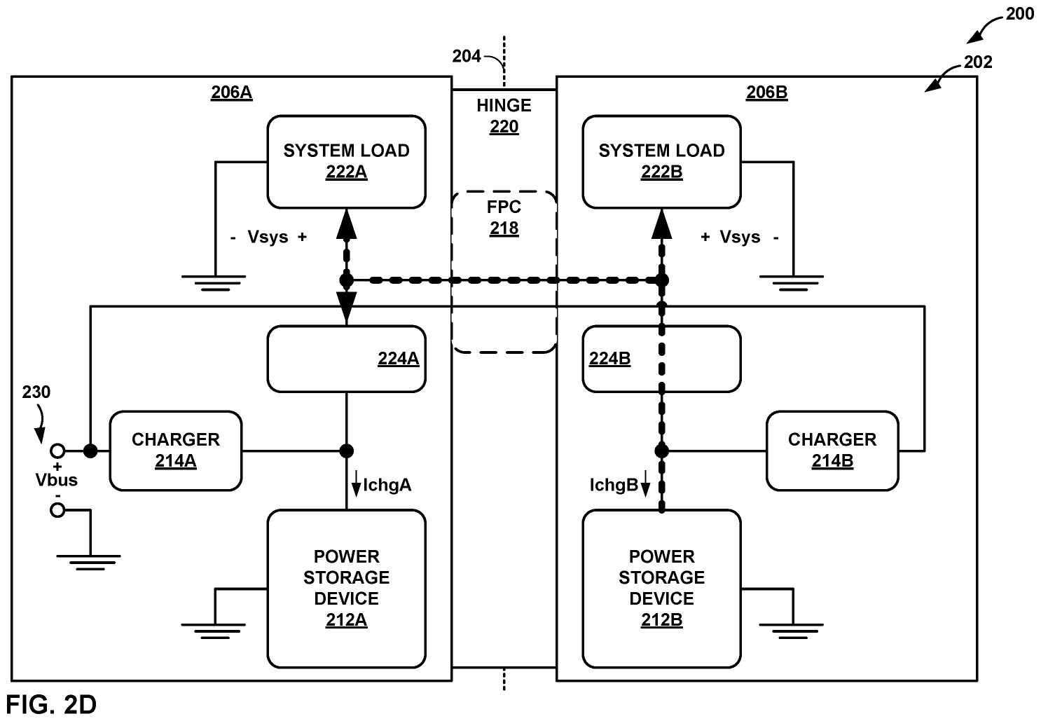

FIGS. 2A-2D are signal flow diagrams illustrating example current flow through a foldable mobile device that includes multiple power storage devices and multiple chargers, in accordance with one or more aspects of this disclosure. Foldable mobile computing device 200 of FIGS. 2A and 2B may be considered an example of foldable mobile computing device 100 of FIG. 1. Components of foldable mobile computing device 200 may perform operations similar to components of foldable mobile computing device 100 with like two-digit suffixes. For instance, charger 214A may perform operations similar to charger 114A.

FIGS. 2A and 2B illustrate example current flows during charging (e.g., when chargers 214 are outputting power signals to charge power storage devices 212). FIG. 2A illustrates an example flow of current output by charger 214A (e.g., the flow of current output by a charger on first side 106A) and FIG. 2B illustrates an example flow of current output by charger 214B (e.g., the flow of current output by a charger on first side 106B). As can be seen in FIG. 2A, current of the power signal output by charger 214A may flow through reverse blocking component 224A, across FPC 218, but is prevented from flowing through reverse blocking component 224B. Similarly, as can be seen in FIG. 2B, current of the power signal output by charger 214B may flow through reverse blocking component 224B, across FPC 218, but is prevented from flowing through reverse blocking component 224A.

FIGS. 2C and 2D illustrate example current flows during operating using stored power (e.g., when electrical energy is being drawn from power storage devices 212). FIG. 2C illustrates an example flow of current sourced from power storage device 212A and FIG. 2D illustrates an example flow of current sourced from power storage device 212B. As can be seen in FIG. 2C, current sourced from power storage device 212A may flow through reverse blocking component 124A to system load 222A, across FPC 218 to system load 222B, but is prevented from flowing through reverse blocking component 224B. Similarly, as can be seen in FIG. 2D, current sourced from power storage device 212B may flow through reverse blocking component 224B to system load 222B, across FPC 218 to system load 222A, but is prevented from flowing through reverse blocking component 224A.

Therefore, in some examples, system loads 222 may operate using electrical power sourced, in parallel, from power storage device 212A and power storage device 212B. The electrical power sourced by system loads 222 from power storage device 212A may flow through reverse blocking component 224A and the electrical power sourced by system loads 222 from power storage device 212B may flow through reverse blocking component 224B.

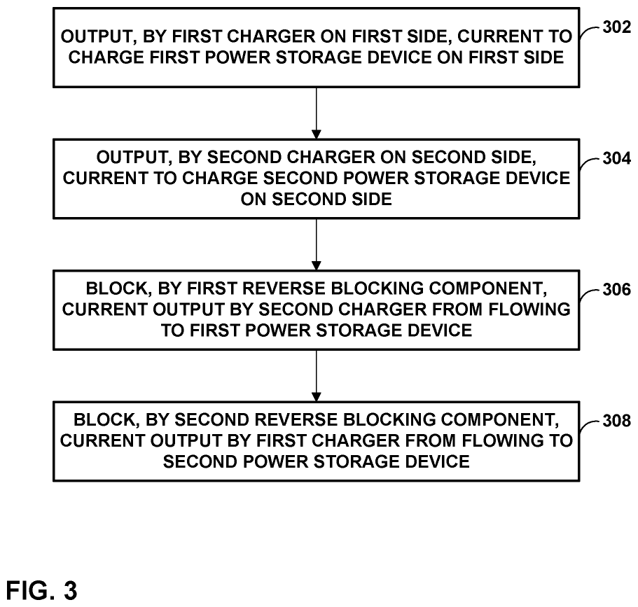

FIG. 3 is a flow diagram illustrating example operations of a foldable mobile device that includes multiple power storage devices and multiple chargers, in accordance with one or more techniques of this disclosure. Although described with reference to foldable mobile computing device of FIG. 1, the operations of FIG. 3 may be performed by components of any suitable foldable mobile device.

A first charger of foldable computing device 100 may output current to charge a first power storage device located on a first side of foldable computing device 100 (302). For instance, charger 114A may output, using electrical energy received via power receiving component 130, a power signal such that an amount of current IchgA flows to first power storage device 112A. As discussed above, to charge first power storage device 112A at a 1C charge rate, charger 114A may adjust the power signal such that IchgA represents the capacity of first power storage device 112A. For instance, if the capacity of first power storage device 112A is 2500 mAh, charger 114A may output the power signal such that IchgA is 2500 mA.

A second charger of foldable computing device 100 may output current to charge a second power storage device located on a second side of foldable computing device 100 (304). For instance, charger 114B may output, using electrical energy received via power receiving component 130, a power signal such that an amount of current IchgB flows to second power storage device 112B. As discussed above, to charge power storage device 112B at a 1C charge rate, charger 114B may adjust the power signal such that IchgB represents the capacity of second power storage device 112B. For instance, if the capacity of second power storage device 112B is 7250 mAh, charger 114B may output the power signal such that IchgB is 7250 mA.

A first reverse blocking component of foldable computing device 100 may block current output by the second charger from flowing to the first power storage device (306). For instance, reverse blocking component 124A may block current output by charger 114B from flowing to first power storage device 112A.

A second reverse blocking component of foldable computing device 100 may block current output by the first charger from flowing to the second power storage device (308). For instance, reverse blocking component 124B may block current output by charger 114B from flowing to second power storage device 112B.

As discussed above, by performing blocking (306, 308), the first charger and the second charger may be able to control the current levels used to charge the power storage devices. For instance, where the power storage devices have different capacities, performing blocking (306, 308) may enable the first charger to charge the first power storage device at a 1C charge rate and enable the second charger to charge the second power storage device at a 1C charge rate without having to include regulators that undesirably consume power and generate heat.

The following numbered examples may illustrate one or more aspects of the disclosure:
Example 1. A foldable mobile computing device comprising: a first side comprising: a first power storage device; a first charger configured to output current to charge the first power storage device; and a first reverse blocking component; a second side configured to articulate relative to the first side about a hinge, the second side comprising: a second power storage device; a second charger configured to output current to charge the second power storage device; and a second reverse blocking component; a flexible printed circuit connected to the first side and the second side; and one or more components configured to operate using electrical power sourced, in parallel, from the first power storage device and the second power storage device, wherein the electrical power sourced by the one or more components from the first power storage device flows through the first reverse blocking component and the electrical power sourced by the one or more components from the second power storage device flows through the second reverse blocking component.
Example 2. The foldable mobile computing device of example 1, wherein a first set of components of the one or more components is located on the first side, and wherein a second set of components of the one or more components is located on the second side.
Example 3. The foldable mobile computing device of example 1, wherein a capacity of the first power storage device is different than a capacity of the second power storage device.
Example 4. The foldable mobile computing device of example 1, wherein the first side does not include a regulator electrically between the first charger and the first power storage device, and wherein the second side does not include a regulator electrically between the second charger and the second power storage device.
Example 5. The foldable mobile computing device of example 1, wherein the first charger is configured to charge the first power storage device at a 1C charge rate, and wherein the second charger is configured to charge the second power storage device at a 1C charge rate.
Example 6. The foldable mobile computing device of example 1, wherein the first charger and the second charger operate using the electrical power received via a power receiving component located on the first side.
Example 7. The foldable mobile computing device of example 1, wherein the first charger comprises a first switched-mode power supply, and wherein the second charger comprises a second switched-mode power supply.
Example 8. The foldable mobile computing device of example 1, wherein the one or more components include a display and one or more processors.
Example 9. The foldable mobile computing device of example 8, wherein the one or more processors are located on the first side, wherein a capacity of the first power storage device is less than a capacity of the second power storage device, wherein a level of the current output by the first charger to charge the first power storage device is less than a level of the current output by the second charger to charge the second power storage device, wherein the first charger is configured to charge the first power storage device at a 1C charge rate, and wherein the second charger is configured to charge the second power storage device at a 1C charge rate.
Example 10. A method comprising: outputting, at a first time and by a first charger located on a first side of a foldable mobile computing device, current to charge a first power storage device located on the first side; outputting, at the first time and by a second charger located on a second side of the foldable mobile computing device, current to charge a second power storage device located on the second side; blocking, at the first time and by a first reverse blocking component, current output by the second charger from flowing to the first power storage device; and blocking, at the first time and by a second reverse blocking component, current output by the first charger from flowing to the second power storage device.
Example 11. The method of example 10, further comprising: operating, at a second time and using electrical power sourced from both the first power storage device and the second power storage device, one or more components of the foldable mobile computing device, wherein the electrical power sourced by the one or more components from the first power storage device flows through the first reverse blocking component and the electrical power sourced by the one or more components from the second power storage device flows through the second reverse blocking component; blocking, at the second time and by the first reverse blocking component, current output by the second power storage device from flowing to the first power storage device; and blocking, at the second time and by the second reverse blocking component, current output by the first power storage device from flowing to the second power storage device.
Example 12. The method of example 10, wherein a capacity of the first power storage device is different than a capacity of the second power storage device.
Example 13. The method of example 12, wherein: outputting, by the first charger, the current to charge the first power storage device comprises outputting, by the first charger, the current to charge the first power storage device at a 1C charge rate; and outputting, by the second charger, the current to charge the second power storage device comprises outputting, by the second charger, the current to charge the second power storage device at a 1C charge rate.
Example 14. The method of example 12, further comprising: transporting, by a flexible printed circuit connected to the first side and the second side, at least some electrical power sourced from the second power storage device to the first side.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A foldable mobile computing device comprising:
a first side comprising:
a first power storage device;
a first charger configured to output current to charge the first power storage device; and
a first reverse blocking component;
a second side configured to articulate relative to the first side about a hinge, the second side comprising:
a second power storage device;
a second charger configured to output current to charge the second power storage device; and
a second reverse blocking component;
a flexible printed circuit connected to the first side and the second side; and
one or more components configured to operate using electrical power sourced, in parallel, from the first power storage device and the second power storage device, wherein the electrical power sourced by the one or more components from the first power storage device flows through the first reverse blocking component and the electrical power sourced by the one or more components from the second power storage device flows through the second reverse blocking component.

2. The foldable mobile computing device of claim 1, wherein a first set of components of the one or more components is located on the first side, and wherein a second set of components of the one or more components is located on the second side.

3. The foldable mobile computing device of claim 1, wherein a capacity of the first power storage device is different than a capacity of the second power storage device.

4. The foldable mobile computing device of claim 1, wherein the first side does not include a regulator electrically between the first charger and the first power storage device, and wherein the second side does not include a regulator electrically between the second charger and the second power storage device.

5. The foldable mobile computing device of claim 1, wherein the first charger is configured to charge the first power storage device at a 1C charge rate, and wherein the second charger is configured to charge the second power storage device at a 1C charge rate.

6. The foldable mobile computing device of claim 1, wherein the first charger and the second charger operate using the electrical power received via a power receiving component located on the first side.

7. The foldable mobile computing device of claim 1, wherein the first charger comprises a first switched-mode power supply, and wherein the second charger comprises a second switched-mode power supply.

8. The foldable mobile computing device of claim 1, wherein the one or more components include a display and one or more processors.

9. The foldable mobile computing device of claim 8, wherein the one or more processors are located on the first side, wherein a capacity of the first power storage device is less than a capacity of the second power storage device, wherein a level of the current output by the first charger to charge the first power storage device is less than a level of the current output by the second charger to charge the second power storage device, wherein the first charger is configured to charge the first power storage device at a 1C charge rate, and wherein the second charger is configured to charge the second power storage device at a 1C charge rate.

10. A method comprising:
outputting, at a first time and by a first charger located on a first side of a foldable mobile computing device, current to charge a first power storage device located on the first side;
outputting, at the first time and by a second charger located on a second side of the foldable mobile computing device, current to charge a second power storage device located on the second side;
blocking, at the first time and by a first reverse blocking component, current output by the second charger from flowing to the first power storage device; and
blocking, at the first time and by a second reverse blocking component, current output by the first charger from flowing to the second power storage device.

11. The method of claim 10, further comprising:
operating, at a second time and using electrical power sourced from both the first power storage device and the second power storage device, one or more components of the foldable mobile computing device, wherein the electrical power sourced by the one or more components from the first power storage device flows through the first reverse blocking component and the electrical power sourced by the one or more components from the second power storage device flows through the second reverse blocking component;
blocking, at the second time and by the first reverse blocking component, current output by the second power storage device from flowing to the first power storage device; and
blocking, at the second time and by the second reverse blocking component, current output by the first power storage device from flowing to the second power storage device.

12. The method of claim 10, wherein a capacity of the first power storage device is different than a capacity of the second power storage device.

13. The method of claim 12, wherein:
outputting, by the first charger, the current to charge the first power storage device comprises outputting, by the first charger, the current to charge the first power storage device at a 1C charge rate; and
outputting, by the second charger, the current to charge the second power storage device comprises outputting, by the second charger, the current to charge the second power storage device at a 1C charge rate.

14. The method of claim 12, further comprising:
transporting, by a flexible printed circuit connected to the first side and the second side, at least some electrical power sourced from the second power storage device to the first side.

15. The foldable mobile computing device of claim 1,
wherein current output by the first charger and current output by the first power storage device are blocked from flowing to the second power storage device by the second reverse blocking component, and
wherein current output by the second charger and current output by the second power storage device are blocked from flowing to the first power storage device by the first reverse blocking component.
